(19) United States
(12) Patent Application Publication
(10) Pub. No.: US 2026/0198512 A1
(43) Pub. Date: Jul. 16, 2026

(54) COCOA-FREE CHOCOLATE COMPOSITIONS AND PRODUCTS AND METHODS FOR PRODUCING SAME

(71) Applicant: WNWN FOOD LABS LTD, London (GB)

(72) Inventor: Johnny DRAIN, Droitwich Spa (GB)

(21) Appl. No.: 19/114,559

(22) PCT Filed: Sep. 26, 2023
(86) PCT No.: PCT/IL2023/051035

§ 371 Date: Mar. 24, 2025

Related U.S. Application Data
(60) Provisional application No. 63/410,408, filed on Sep. 27, 2022.

(51) Int. Cl. A23G 1/34; A23C 11/10; A23G 1/02; A23G 1/38; A23G 1/48; A23L 7/104; A23L 11/00

(52) U.S. Cl. CPC A23G 1/34; A23C 11/103; A23G 1/02; A23G 1/38; A23G 1/48; A23L 7/104; A23L 11/05

(57) ABSTRACT

The present invention provides cocoa-free chocolate compositions and products made from non-animal, or plant-based, ingredients, and methods for preparation thereof.

### TECHNOLOGICAL FIELD

The present invention provides cocoa substitutes and methods for preparation thereof, and, more particularly, cocoa-free chocolate compositions and products.

### BACKGROUND

Around 75% of all chocolate consumed worldwide comes from cacao produced in Ghana and Cote d′Ivoire, which border each other in West Africa. In the last 60 years, Ghana has lost 80% of its forest cover, Cote d′Ivoire 94%. A third of this is directly attributable to cacao production.

Moreover, about 1 million child laborers work in cacao production in Ghana and Cote D'Ivoire. About 95% of them are exposed to the worst forms of child labor, such as working with dangerous tools or harmful pesticides.

According to the food justice organization Food Empowerment Project (F.E.P.), child labor, slave labor, and human trafficking have become commonplace in the cacao industry. Even though there are a number of certification programs meant to ensure that cacao is harvested in ways that fairly treat workers and the environment, there is a lot of evidence that rules are often not enforced on cacao farms.

In addition, chocolate production from cacao beans is associated with high levels of greenhouse emission and water usage.

Therefore, there is still a need for an ethical and environmentally sustainable chocolate substitute which is tasty, harm-free and guilt-free.

### SUMMARY

According to some embodiments, provided herein are a cacao-free, or cocoa-free chocolate compositions and products, and methods for their preparation.

Advantageously, the cocoa-free chocolate may be made from non-animal, or plant-based, ingredients combined with chocolate-making know-how and fermentation techniques, using ethical and sustainable ingredients and procedures. Advantageously, the cocoa-free chocolate may have the properties of conventional chocolate, such as taste, aroma, mouthfeel snap, texture, melt properties, bake properties, organoleptic properties etc. Further, the cocoa-free chocolate may advantageously be free of palm oil, caffeine, gluten, animal ingredients, dairy products, and/or theobromine. As a further advantage, the herein disclosed cocoa-free chocolate may be lower in saturated fats and/or sugars, as compared to conventional chocolate. This may make the cocoa-free chocolate suitable for vegans, people suffering from lactose intolerance, gluten intolerance, and/or other gastrointestinal sensitivities. According to some embodiments, the cocoa-free chocolate may be at least 5%, at least 10% or at least 20% lower in total sugars and/or added refined sugars than conventional chocolates, while being rich in polyphenol antioxidants. According to some embodiments, the cocoa-free chocolate may include at least 1%, at least 5% or at least 10% less saturated fats than conventional chocolates.

Some embodiments relate to a cocoa-free chocolate composition comprising:
1-65% wt of at least one non-animal fat;
5-55% wt of at least one legume component; and
0.1-25% wt of at least one fermented cereal grain.

According to some embodiments, the non-animal fat may comprise a plant-based fat.

According to some embodiments, the at least one non-animal fat may be selected from the group consisting of: shea butter, illipe butter, palm oil, palm kernel oil, sal nut oil, kokum butter, mango kernel butter, algae-derived fats, coconut oil, cocoa butter substitutes (CBS), cocoa butter replacers (CBR), cocoa butter equivalents (CBE), Soybean oil, Rapeseed oil, Cottonseed oil, Cupuaçu Butter, Bambangan Kernel Fat, canola oil, sunflower oil, safflower oil, peanut oil, rice bran oil, and any combination thereof. Each possibility is a separate embodiment. In some embodiments, the at least one non-animal fat comprises shea butter, illipe butter and/or palm oil. In some embodiments, the at least one non-animal fat comprises shea butter and illipe butter. In some embodiments, the at least one non-animal fat comprises shea butter and palm oil.

According to some embodiments, the non-animal fat may be melted.

According to some embodiments, the at least one legume component may be selected from the group consisting of: carob, soybeans, peas, chickpeas, peanuts, lentils, lupins, mesquite, tamarind, alfalfa, clover, fava bean (faba, broad bean), and any combination thereof. Each possibility is a separate embodiment. In some embodiments, the legume component comprises carob powder and/or roasted carob powder.

According to some embodiments, the roasted carob powder may comprise at least two roasted carob powders which have been roasted at different temperatures and/or for different lengths of time.

According to some embodiments, the at least one legume comprises carob powder, and the at least one fermented cereal grain comprises roasted fermented barley paste.

According to some embodiments, the at least one fermented cereal grain may be selected from the group consisting of: barley, pearl barley, tiger nuts, rice, wheat, millet, maize, triticale, rye, fonio, teff, amaranth, soy, quinoa, sorghum, oats, linseed, bulgur, tomato, any by-products thereof, and any combination thereof. Each possibility is a separate embodiment. In some embodiments, the at least one fermented cereal grain may comprise barley. In some embodiments, the at least one fermented cereal grain may comprise roasted fermented barley.

According to some embodiments, the cocoa-free chocolate composition may comprise at least one sweetener. According to some embodiments, the at least one sweetener is present in the composition at an amount of about 0.1-50% wt. According to some embodiments, the at least one sweetener may be selected from the group consisting of: white sugar, palm sugar, coconut sugar, unrefined sugar, brown sugar, light brown sugar, demerara sugar, turbinado sugar, cane sugar, glucose, fructose, stevia, erythritol, xylitol, mannitol, agave nectar, Yacon syrup, honey, maple, molasses, coconut sugar, Monk fruit sweetener, aspartame, acesulfame potassium, advantame, aspartame-acesulfame salt, cyclamate, neotame, neohesperidin, saccharine, sucralose, and any combination thereof. Each possibility is a separate embodiment.

According to some embodiments, the cocoa-free chocolate composition may comprise at least one emulsifier. According to some embodiments, the at least one emulsifier is present in the composition at an amount of about 0.1-1% wt. According to some embodiments, the at least one emulsifier may be selected from the group consisting of: sunflower lecithin, soy lecithin, polyglycerol polyricinoleate (PGPR), E322 Lecithins, E492, and Sorbitan tristearate. Each possibility is a separate embodiment. In some embodiments, the emulsifier comprises sunflower lecithin.

According to some embodiments, the cocoa-free chocolate composition may comprise at least one flavor or aroma agent. According to some embodiments, the at least one flavor or aroma agent is selected from the group consisting of: a spice, herb, fruit, vegetable, seed, nut, flower, salt, and any combination thereof. According to some embodiments, the flavor or aroma agent is selected from salt, tiger nut, grape seed, sunflower seed flour, cherries, rose hips, vanilla, malted barley, pumpkin seed flour, fermented soy beans, and any combinations thereof.

According to some embodiments, the cocoa-free chocolate composition may comprise at least one texture agent selected from the group consisting of: a chip, a hard compound, a seed, a flake, puffed rice, nibs, a fruit, freeze-dried materials, a sticky compound, toffee, caramel, a soft compound, mousse, puree, liquor, spirit, and combinations thereof. Each possibility is a separate embodiment.

According to some embodiments, the cocoa-free chocolate composition may comprise at least one of a thickener, a binder, disintegrant, a stabilizer, a flavor enhancer, an emulsifier, a pH modifier, or a combination thereof. Each possibility is a separate embodiment.

According to some embodiments, the cocoa-free chocolate composition may not comprise a dairy product.

According to some embodiments, the cocoa-free chocolate composition may comprise a non-dairy milk component. According to some embodiments, the non-dairy milk component may be made from the group consisting of: oats, potatoes, tiger nut, soy, rice, hazelnut, hemp, macadamia, almond, peanut, grains, barley, quinoa, peas, coconut, and any combination thereof. Each possibility is a separate embodiment. In some embodiments, the non-dairy milk component comprises oat milk.

According to some embodiments, the cocoa-free chocolate composition comprises less than 25% wt sugar.

According to some embodiments, the at least one fermented cereal grain and the at least one legume component are present at a ratio of about 1:5-1:25 wt/wt in the cocoa-free chocolate composition.

According to some embodiments, the at least one legume comprises carob powder, and the at least one fermented cereal grain comprises roasted fermented barley. According to some embodiments, the roasted fermented barley is present in the composition in an amount of about 0.5-15% wt, and the carob powder is present in the composition in an amount of about 8-40% wt.

According to some embodiments, the non-animal fat comprises shea butter, illipe butter, and/or palm oil, and is present in the composition in an amount of about 30-50% wt.

According to some embodiments, the cocoa-free chocolate composition does not contain particles larger than 70 microns. According to some embodiments, the composition comprises particles of which at least 90% have a size smaller than about 30 microns.

Some embodiments relate to a cocoa-free chocolate product prepared from the cocoa-free chocolate composition described herein.

According to some embodiments, the cocoa-free chocolate product may be in the form of a chocolate candy, a chocolate bar, a chocolate paste, a chocolate spread, a chocolate drink, a chocolate topping, or a chocolate filling. Each possibility is a separate embodiment.

Some embodiments relate to a method for the preparation of a cocoa-free chocolate composition comprising:
fermenting a cereal grain;
roasting the fermented cereal grain; and
mixing the roasted fermented cereal grain with at least one non-animal fat and at least
one legume component, to form a cocoa-free chocolate composition comprising:
   1-65% wt of the at least one non-animal fat;
   5-55% wt of the at least one legume component; and
   0.1-25% wt of the roasted fermented cereal grain.

According to some embodiments, the method comprises melting the non-animal fat prior to mixing with the roasted fermented cereal grain the legume component.

According to some embodiments, the method further comprises adding at least one sweetener at an amount of 0.1-50% wt of the composition. According to some embodiments, the method further comprises adding at least one emulsifier at an amount of 0.1-1% wt of the composition.

According to some embodiments, the fermenting is performed by incubating the cereal grain with at least one microorganism selected from the group consisting of Aspergillus oryzae, Bacillus subtilis, Aspergillus sojae, Rhizopus oligosporus, Rhizopus oryzae, Neurospora intermedia var. Oncomensis, Aspergillus luchuensis, Lactococcus lactis subsp, B, Bacillus sp., Bacillus licheniformis, Bacillus giant, Bacillus pumilus, Bacillus amylolitica, Bacillus methylotrophic, Bacillus proteolysaccharide, Bacillus brevis, Laceyella Sacchari, Corynebacterium glutamicum, Saccharomyces cerevisiae, Candida krusei, Candida parapsilosis, Candida glabrata, Candida tropicalis, Candida guillermondii, Candida rugosa, Pichia kudriavzevii, and any combination thereof. According to some embodiments, the at least one microorganism is Aspergillus oryzae and/or Bacillus subtilis.

According to some embodiments, roasting the fermented cereal grain is conducted at a temperature of about 30-65° C.

According to some embodiments, the mixing further comprises grinding until the composition comprises particles of which at least 90% have a size smaller than about 30 microns.

According to some embodiments, the method further includes adding at least one of a thickener, binder, disintegrant, stabilizer, flavor enhancer, flavor agent, an aroma agent, a texture agent, or a combination thereof. Each possibility is a separate embodiment.

According to some embodiments, the method may comprise tempering the cocoa-free chocolate composition, and/or molding the tempered cocoa-free chocolate composition into a desired form.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 is a flowchart of steps in an exemplary process for preparing a cocoa-free chocolate composition and product, according to some embodiments.

FIG. 2 is a comparative graph of the temper curves of 4 samples as measured on a TRICOR Temper Meter, in accordance with some embodiments.

FIG. 3 is an exemplary photograph of a Cup Flow Test comparison of 4 samples, in accordance with some embodiments.

FIG. 4 is a chart showing the hardness of 4 samples after 1 day and after 1 week, in accordance with some embodiments.

FIG. 5 is a chart showing the viscosity and yield stress of 4 samples, in accordance with some embodiments.

FIG. 6 is a chart showing cyclical shelf-life tests of 4 samples cycling the storage temperature from 25° C. to 31° C. over a period of 2 weeks, in accordance with some embodiments.

FIG. 7 is a chart showing the contraction behavior of 4 samples of cocoa-free dark chocolate compared to a sample of conventional cocoa-containing dark chocolate, in accordance with some embodiments.

FIGS. 8A and 8B are charts showing raw contraction data from an Aasted ChocoAnalyzer machine for a sample of conventional cocoa-containing dark chocolate compared to a sample of cocoa-free dark chocolate.

FIGS. 9A and 9B are charts showing results of a sensory analysis of an overall chocolate evaluation for conventional cocoa-containing chocolate (STD) and cocoa-free chocolate (WNWN).

FIGS. 10A and 10B are charts showing results of a sensory analysis testing the closeness to chocolate for conventional cocoa-containing chocolate (STD) and cocoa-free chocolate (WNWN).

FIGS. 11A and 11B are charts showing results of a sensory analysis testing the response to the question of whether the product was chocolate, for conventional cocoa-containing chocolate (STD) and cocoa-free chocolate (WNWN).

FIGS. 12A and 12B are comparative spider plots showing results of a sensory analysis of chocolate characteristics for conventional cocoa-containing chocolate (STD) and cocoa-free chocolate (WNWN).

### DETAILED DESCRIPTION OF EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Chocolate is a food made from roasted and ground cacao seed kernels. Generally, chocolate is produced by fermenting and roasting cacao seeds, followed by removing the shells to produce cocoa nibs, which are ground to cocoa mass. The mass is liquefied by heating and processed into cocoa solids and cocoa butter, which are used in chocolate products.

The present invention provides cocoa-free chocolate substitutes (herein referred to as cocoa-free chocolate), which have taste and appearance characteristics similar to chocolate, but do not contain ingredients derived from cacao seeds.

According to some embodiments, the present invention provides a cocoa substitute and method for preparation thereof, and, more particularly, but not exclusively, a cocoa-free chocolate composition and product, and methods for their preparation. Optionally, the cocoa-free chocolate composition or product may be made from non-animal ingredients, or from plant-based ingredients. Optionally, the cocoa-free chocolate composition or product may have the properties of conventional chocolate, such as taste, aroma, snap, texture, contraction, flow, melting, baking, etc. Optionally, the cocoa-free chocolate composition or product may be free of palm oil, caffeine, gluten, animal ingredients, dairy products, and/or theobromine. Optionally, the cocoa-free chocolate composition or product may be suitable for vegans (and not include dairy products), people suffering from lactose intolerance, gluten intolerance, and/or other gastrointestinal sensitivities, such as but not limited to orofacial granulomatosis, acute allergic reactions from food groups that have natural benzoates and cinnamates and the like. Optionally, the cocoa-free chocolate composition or product may be lower in sugar than conventional chocolates. As a non-limiting example, the herein disclosed cocoa-free chocolate composition or product may include about 15-30 g sugar per 100 gr cocoa-free chocolate, whereas conventional chocolate typically includes about 50 g sugar per 100 grams. Optionally, the cocoa-free chocolate composition or product may be lower in saturated fats than conventional chocolates. Optionally, the cocoa-free chocolate composition or product may be higher in dietary fiber than conventional chocolates.

According to some embodiments, the cocoa-free chocolate composition or product may be rich in polyphenol antioxidants.

Some embodiments relate to a cocoa-free chocolate composition comprising at least one non-animal fat, at least one legume component and at least one fermented cereal grain.

According to some embodiments, the cocoa-free chocolate composition is essentially devoid of cacao bean-derived ingredients. According to some embodiments, the cocoa-free chocolate composition is essentially devoid of cacao seed-derived ingredients. According to some embodiments, the cocoa-free chocolate composition is essentially devoid of cacao powder or cocoa powder. According to some embodiments, the cocoa-free chocolate composition is essentially devoid of cocoa solids or cocoa butter.

According to some embodiments, the cocoa-free chocolate composition may comprise about 1-65% wt of at least one non-animal fat; about 5-55% wt of at least one legume component; and about 0.1-25% wt of at least one fermented cereal grain.

The non-animal fat may be any fat or oil that is not of an animal source, such as a fat or oil from a plant or algae, or a synthetic fat or oil. According to some embodiments, the non-animal fat may be a plant-based fat or oil.

According to some embodiments, the non-animal fat is a melted non-animal fat.

According to some embodiments, the at least one non-animal fat may be selected from shea butter, illipe butter, palm oil, palm kernel oil, sal nut oil, kokum butter, mango kernel butter, algae-derived fats, coconut oil, cocoa butter substitutes (CBS), cocoa butter replacers (CBR), cocoa butter equivalents (CBE), soybean oil, rapeseed oil, cottonseed oil, cupuaçu butter, bambangan kernel fat, canola oil, sunflower oil, safflower oil, peanut oil, rice bran oil, and any combination thereof. Each possibility is a separate embodiment.

According to some embodiments, the at least one non-animal fat may comprise shea butter, illipe butter and/or palm oil. In some embodiments, the at least one non-animal fat comprises shea butter and illipe butter. In some embodiments, the at least one non-animal fat comprises shea butter and palm oil. According to some embodiments, the at least one non-animal fat may comprise organic shea butter or illipe butter. According to some embodiments, the at least one non-animal fat may consist of shea butter, illipe butter and/or palm oil.

The process of preparing chocolate usually requires tempering, in order to control crystallization of the fat, and obtain small fat crystals which provide a more glossy appearance for the chocolate, with best snap. Tempering is done by heating and cooling the chocolate several times, which is cumbersome, time-consuming and requires specific technical and expert knowledge.

According to some embodiments, the at least one non-animal fat consists of at least one non-temper fat. According to some embodiments, the at least one non-animal fat does not comprise fat that needs tempering. According to some embodiments, the composition does not comprise fat that needs tempering. When the composition includes only non-temper fat, the processing of the chocolate is simplified by facilitating to simply melt the chocolate composition without the need for tempering.

According to some embodiments, the at least one non-animal fat may be included in the cocoa-free chocolate composition in an amount of about 1-80% wt, 5-75% wt, about 10-75% wt, about 15-70% wt, about 20-65% wt, 25-65% wt, about 20-50% wt, about 30-50% wt, or any other range within the range of about 1-80% wt. Each possibility is a separate embodiment.

According to some embodiments, the at least one legume component may be selected from carob, soybeans, peas, chickpeas, peanuts, lentils, lupins, mesquite, tamarind, alfalfa, fava bean (faba, broad bean), clover, and any combination thereof. Each possibility is a separate embodiment.

According to some embodiments, the at least one legume component may comprise carob. According to some embodiments, the at least one legume component may consist of carob.

Optionally, the legume component may be roasted (i.e., by any of the methods described herein). Optionally, the legume component may be pre-roasted. Optionally, the legume component may be roasted more than once.

According to some embodiments, the at least one legume component may be roasted at a temperature of about 50-250° C., about 100-200° C., about 50-100° C., about 75-125° C., about 90-150° C., about 150-200° C., about 100-250° C., or about 100-250° C. Each possibility is a separate embodiment.

According to some embodiments, the legume component may be roasted for a time length of about 3-30 minutes, about 1-210 minutes, about 1-180 minutes, about 1-120 minutes, about 1-60 minutes, 5-25 mins, 5-15 mins, 5-10 mins, 10-30 mins, 20-30 mins or about 1-30 minutes, or any other sub-range between about 1-210 minutes. Each possibility is a separate embodiment.

According to some embodiments, the at least one legume component may be included in the cocoa-free chocolate composition in an amount of about 0.1-65% wt, about 1-65% wt, about 5-55% wt, about 5-50% wt, about 8-40% wt, about 5-35% wt, about 9-32% wt, about 15-25% wt, about 15-20% wt, or any other sub-range within the range of about 0.1-65% wt. Each possibility is a separate embodiment.

According to some embodiments, the legume component may be a carob powder. Optionally, the carob powder may be a blend of two or more carob powders. Optionally, the two or more carob powders in the blend of carob powders may come from different sources. Optionally, the carob powder may include at least two carob powders roasted at different temperatures and/or for different time lengths. Optionally, the carob powder may be pre-roasted.

According to some embodiments, the legume (e.g., the carob) may be fermented, either separately or together with the cereal grain, as further discussed below.

According to some embodiments, the at least one fermented cereal grain may be selected from the group consisting of: barley, pearl barley, tiger nuts, rice, wheat, millet, maize, triticale, rye, fonio, teff, amaranth, soy, quinoa, sorghum, oats, linseed, bulgur, tomato, any by-products and any byproducts thereof including but not limited to husks and downstream waste streams of those products (e.g. barley spent grain a by-product of brewing beer), and/or any combination thereof. Each possibility is a separate embodiment.

According to some embodiments, the at least one fermented cereal grain may be roasted. According to some embodiments, the at least one fermented cereal grain may be in the form of a paste.

According to some embodiments, the at least one fermented cereal grain may comprise barley. According to some embodiments, the at least one fermented cereal grain may consist of barley. In an embodiment, the at least one fermented cereal grain may be roasted fermented barley. In an embodiment, the at least one fermented cereal grain may be roasted fermented barley paste.

According to some embodiments, the at least one fermented cereal grain may comprise at least two fermented cereal grains, which have been fermented and/or roasted under different conditions, as further described below, with reference to the methods.

According to some embodiments, the at least one fermented cereal grain may be included in the cocoa-free chocolate composition in an amount of about 0.1-65% wt, about 0.1-40% wt, about 0.1-25% wt, about 0.1-20% wt, about 0.1-15% wt, about 0.5-65% wt, about 0.5-40% wt, about 0.5-15% wt, about 1-40% wt, about 1-25% wt, about 1-20% wt, about 1-15% wt, about 5-20% wt, or any other sub-range within the range of 0.1-65% wt. Each possibility is a separate embodiment.

According to some embodiments, the cereal grain may be fermented by incubation with at least one microorganism. The incubation may be with a starter culture of the microorganism. In some embodiments, the starter culture includes spores of the microorganism. Optionally, the microorganism may be a fungus, and/or bacteria. According to some embodiments, the fungus may be a yeast. Optionally, the at least one microorganism may be a fungus selected from Aspergillus oryzae, Aspergillus sojae, Aspergillus luchuensis Rhizopus oligosporus, Rhizopus oryzae, Neurospora intermedia var. Oncomensis, or any combination thereof. Each possibility is a separate embodiment. Optionally, the at least one microorganism may be a bacteria selected from Bacillus subtilis, Lactococcus lactis subsp, B, Bacillus sp., Bacillus licheniformis, Bacillus giant, Bacillus pumilus, Bacillus amylolitica, Bacillus methylotrophic, Bacillus proteolysaccharide, Bacillus brevis, Laceyella Sacchari, Corynebacterium glutamicum, or any combination thereof. Each possibility is a separate embodiment. Optionally, the at least one microorganism may be a yeast selected from Saccharomyces cerevisiae, Candida krusei, Candida parapsilosis, Candida glabrata, Candida tropicalis, Candida guillermondii, Candida rugosa, Pichia kudriavzevii, or any combination thereof. Each possibility is a separate embodiment.

According to some embodiments, the microorganism may comprise more than one microorganism. According to some embodiments, the microorganism may be selected from any fungus (including yeast) and bacteria mentioned above, and any combinations thereof. Optionally, the microorganism may be selected to provide a specific flavor, aroma, and/or texture profile.

According to some embodiments, the cocoa-free chocolate composition may further comprise a malted cereal. According to some embodiments, the malted cereal may be malted barley. According to some embodiments, the malted cereal may be present in the chocolate in an amount of about 0.01-10% wt, 0.01-5% wt, 0.1-10% wt, 0.1-5% wt, 0.5-10% wt, 0.5-8% wt, 0.5-5% wt, or less than 1% wt. Each possibility is a separate embodiment.

According to some embodiments, the cocoa-free chocolate composition may include at least one sweetener. Optionally, the sweetener may be natural and/or synthetic/artificial. Optionally, the at least one sweetener may be selected from white sugar, palm sugar, coconut sugar, unrefined sugar, brown sugar, light brown sugar, demerara sugar, turbinado sugar, cane sugar, glucose, fructose, stevia, erythritol, xylitol, mannitol, agave nectar, Yacon syrup, honey, maple, molasses, coconut sugar, Monk fruit sweetener, aspartame, acesulfame potassium, advantame, aspartame-acesulfame salt, cyclamate, neotame, neohesperidin, saccharine, sucralose, and/or any combination thereof. Each possibility is a separate embodiment.

According to some embodiments, the at least one sweetener may be included in the cocoa-free chocolate composition in an amount of about 0.1-50% wt, about 0.1-45% wt, about 0.1-40% wt, about 1-50% wt, about 5-50% wt, about 5-40% wt, about 5-30% wt, about 5-20% wt, about 10-40% wt, about 14-35% wt, or any other sub-range within the range of 0.1-50% wt. Each possibility is a separate embodiment.

According to some embodiments, the cocoa-free chocolate composition may include at least one emulsifier. Optionally, the at least one emulsifier may be selected from sunflower lecithin, soy lecithin, polyglycerol polyricinoleate (PGPR), E322 lecithins, E492, sorbitan tristearate, etc., and any combination thereof. Each possibility is a separate embodiment.

According to some embodiments, the at least one emulsifier may be included in the cocoa-free chocolate composition in an amount of about 0.05-5% wt, about 0.1-3% wt, about 0.1-2% wt, about 0.1-1% wt, about 0.2-1% wt, about 0.2-0.8% wt, or any other range within the range of 0.05-5% wt. Each possibility is a separate embodiment.

According to some embodiments, the cocoa-free chocolate composition may further include at least one flavoring agent. Optionally, the flavoring agent may be a natural flavoring substance (i.e., flavoring substances obtained from plant or animal raw materials, by physical, microbiological or enzymatic processes), a nature-identical flavoring substance (i.e., flavoring substances that obtained by synthesis or isolated through chemical processes, which are chemically and organoleptically identical to flavoring substances naturally present in products intended for human consumption) or an artificial flavoring substance (i.e., chemically produced flavoring substances that are typically chemically different from the corresponding natural flavoring substance however, in sensory characteristics are the same as natural ones), and/or any combination thereof.

According to some embodiments, a flavoring agent may be selected from a spice, herb, fruit, vegetable, seed, nut, flower, salt, liquor and/or any combination thereof. Optionally, the spice and/or herb may be selected from vanilla, cinnamon, nutmeg, cardamom, oregano, basil, thyme, coriander, parsley, rosemary, salt, pepper, garlic, maca root, Ligusticum wallichii (commonly known as Szechuan lovage), etc., and combinations thereof. Each possibility is a separate example. Optionally, fruit, vegetable and/or flavors may include banana, strawberry, raspberry, cherry, rose hip, grape, grape seed, orange, pineapple, lemon, melon, carrot, pumpkin, zucchini, sweet potato, yams, beans, etc., and any combinations thereof. Each possibility is a separate example. According to some embodiments, the fruit may be a fruit part such as the seeds of a fruit, the kernel of a fruit, the peel of a fruit, the flesh of a fruit, or any combination thereof. Each possibility is a separate embodiment. According to some embodiments, the vegetable may be a vegetable part, such as the seeds of a vegetable, the kernel of a vegetable, the peel of a vegetable, the flesh of a vegetable, or any combination thereof. Each possibility is a separate embodiment. Optionally a flower and/or seed and/or nut may be selected from cherry, rose hip, fruit kernels including apricot kernels, coconut, nuts, sunflower seeds, sunflower seed flower, pumpkin seed, pumpkin seed flour, sesame seeds, jasmine, hibiscus, zucchini blossoms, nasturtiums, lavender, roses, marigolds, anise, hyssop, butterfly pea, violets, pansies, etc. and/or combinations thereof. Each possibility is a separate example. According to some embodiment, the fruit, vegetable, and/or flavor may undergo preparation, such as fermentation, roasting, cooking, drying, freeze-drying, pureeing, chopping, emulsifying, or the like. Each possibility is a separate embodiment.

According to some embodiments, the cocoa-free chocolate composition may further include at least one aroma agent. According to some embodiments, an aroma agent may be selected from a spice, herb, fruit, vegetable, seed, nut, flower, salt, liquor, and/or any combination thereof. Optionally, the spice and/or herb may be selected from vanilla, cinnamon, nutmeg, cardamom, oregano, basil, thyme, coriander, parsley, rosemary, salt, pepper, garlic, maca root, Ligusticum wallichii, etc. and/or combinations thereof. Each possibility is a separate example. Optionally, a fruit, vegetable and/or aroma agent may include banana, strawberry, berry, grape, grape seed, orange, pineapple, lemon, melon, carrot, pumpkin, zucchini, sweet potato, yams, beans, etc. and/or any combinations thereof. Each possibility is a separate example. Optionally, a flower and/or seed may be selected from cherry, rose hip, fruit kernels, coconut, nuts, sunflower seeds, sunflower seed flower, pumpkin seed, pumpkin seed flour, sesame seeds, jasmine, hibiscus, zucchini blossoms, nasturtiums, lavender, roses, marigolds, anise, hyssop, butterfly pea, violets, pansies, etc. and/or combinations thereof. Each possibility is a separate example. According to some embodiment, the aroma agent may undergo preparation, such as fermentation, roasting, cooking, drying, freeze-drying, pureeing, chopping, emulsifying, or the like. Each possibility is a separate embodiment.

In some embodiments, any one of the at least one flavoring or aroma agent may be included in the composition at an amount of about 0.01-20% wt, about 0.01-15% wt, about 0.01-10% wt, about 0.01-5% wt, about 0.01-2% wt, about 0.01-1% wt, about 0.05-20% wt, about 0.05-15% wt, about 0.05-10% wt, about 0.05-5% wt, about 0.05-2% wt, about 0.05-1% wt, about 0.1-20% wt, about 0.1-15% wt, about 0.1-10% wt, about 0.1-5% wt, about 0.1-2% wt, about 0.1-1% wt, about 0.5-20% wt, about 0.5-15% wt, about 0.5-10% wt, about 0.5-5% wt, about 0.5-2% wt, about 0.5-1% wt, about 1-20% wt, about 1-15% wt, about 1-10% wt, about 1-5% wt, about 1-2% wt, about 5-20% wt, about 5-15% wt, or about 5-10% wt.

According to some embodiments, the cocoa-free chocolate composition may include an edible fiber, such as but not limited to inulin, psyllium seed husks, fructooligosaccharides, corn fiber, and the like, or any combination thereof. Each possibility is a separate embodiment.

According to some embodiments, the cocoa-free chocolate composition may include a probiotic culture.

According to some embodiments, the cocoa-free chocolate composition may include a cannabinoid, such as but not limited to cannabidiol (CBD) or a CBD derivative (e.g., cannabidivarin (CBDV), cannabidiolic acid (CBDA), cannabinodiol (CBDN), or any combination thereof. Each possibility is a separate embodiment.

According to some embodiments, the cocoa-free chocolate composition may include at least one thickener. The term “thickener” should be understood to encompass any edible component capable of increasing the viscosity of the composition without substantially changing its other properties (such as, its taste and smell, for example). Non-limiting examples of a thickener are starch such as potato starch, corn flour, arrow root, tapioca, pectin, agar, alginate, gelatin, locust bean gum, sucrose, flour such as buckwheat flour, almond flour, chickpea flour, sorghum flour, etc., and a combination thereof. Each possibility is a separate embodiment.

According to some embodiments, the cocoa-free chocolate composition may include at least one binder. Non-limiting examples of binders are wax, linseed oil, natural gums such as gum arabic, gum tragacanth, methyl cellulose, psyllium husk, flaxseed, chia seeds, proteins, such as egg white or casein, defatted sunflower seed flour, or any combination thereof. Each possibility is a separate embodiment.

According to some embodiments, the cocoa-free chocolate composition may include at least one disintegrant. Non-limiting examples of disintegrants are cassava, native and modified starch, cellulose and its derivatives, such as microcrystalline cellulose, croscarmellose sodium, low-substituted hydroxypropyl cellulose, sodium starch glycolate, resin and its derivatives, crospovidone, etc., and combinations thereof. Each possibility is a separate embodiment.

According to some embodiments, the cocoa-free chocolate composition may include at least one stabilizer. Non-limiting examples of stabilizers are a hydrocolloid, such as xanthan, gum Arabic, gum acacia, tara gum, agar, konjac modified starches, pectin, carrageenan, casein, inulin, locust bean gum, etc., and any combination thereof. Each possibility is a separate embodiment.

According to some embodiments, the cocoa-free chocolate composition may include at least one pH modifying agent. According to some embodiments, the at least one pH modifying agent may be selected from an edible acid and/or edible base. According to some embodiments, the edible acid may be an organic acid and/or an inorganic acid. Optionally, the edible acid may be selected from the group including citric acid, malic acid, acetic acid, tartaric acid, oxalic acid, caffeic acid, tannic acid, benzoic acid, lactic acid, folic acid, pantothenic acid, oleic acid, palmitic acid, etc., and/or combinations thereof. Each possibility is a separate embodiment. According to some embodiments, the edible base may be an alkali metal carbonate, hydroxide, or oxide and/or an alkaline earth metal carbonate, hydroxide, or oxide. Optionally, the edible base may be selected from the group including magnesium oxide, magnesium hydroxide, aluminum hydroxide, ammonium bicarbonate, ammonium carbonate, potassium bicarbonate, potassium carbonate, potassium hydroxide, sodium carbonate, sodium bicarbonate, sodium hydroxide, calcium hydroxide, calcium carbonate, trisodium phosphate, sodium benzoate, etc. and/or combinations thereof. Each possibility is a separate embodiment. According to some embodiments, the at least one pH modifying agent may be an edible buffer.

According to some embodiments, the cocoa-free chocolate composition may further include at least one texture agent. According to some embodiments, the at least one texture agent may be selected from a hard compound, such as chips, nuts, biscuit, popped rice, shredded coconut, seeds, flakes, puffed rice, nibs, dried fruit, freeze-dried materials; a sticky compound, such as toffee, caramel, taffy, honey, fufu, marshmallow, jam, etc.; a soft compound, such as a mouse, puree, flan, chia seeds, tapioca, etc.; and/or a liquid, such as a caramel, puree, truffle, liquor, spirit, etc.; or any combinations thereof. Each possibility is a separate embodiment.

According to some embodiments, the cocoa-free chocolate composition may further include a natural preservative, an oxidating agent, or other food grade agent configured for optimizing the structure, chewability, meltability, shelf-life and/or other feature and/or characteristic of the cocoa-free chocolate composition.

Some more specific, nonlimiting examples for flavor/aroma agents or for other ingredients that may independently be present in the composition include: salt, which may be present in the composition in an amount of about 0.01-1% wt; tiger nut, which may be present in the composition in an amount of about 1-15% wt or about 4-7% wt; grape seeds, which may be present in the composition in an amount of about 0.5-5% wt, or about 1-2.5% wt; sunflower seed flour, which may be present in the composition in an amount of about 0.5-15% wt; cherries, which may be present in the composition in an amount of about 0.05-5%, or about 0.2-1% wt; vanilla, which may be present in the composition in an amount of about 0.01-5% wt, or about 0.01-0.2% wt; malted barley, which may be present in the composition in an amount of about 0.01-5% wt, or about 0.5-0.8% wt; pumpkin seed flour, which may be present in the composition in an amount of about 0.01-15% wt; fermented soy beans, which may be present in the composition in an amount of about 0.01-10% wt; acetic acid, which may be present in the composition in an amount of about 0.05-5% wt; rose hip, which may be present in the composition in an amount of about 0.1-1% wt, or about 0.2-1% wt; and chicory root, which may be present in the composition in an amount of about 0.1-1% wt.

According to some embodiments, the cocoa-free chocolate composition may include a milk component. Optionally, the milk component may be low lactose, or essentially lactose free. According to some embodiments, the milk component may be derived from a dairy product (i.e., from an animal source) such as dairy milk, (e.g., milk derived from a mammal such as, cow, goat, sheep, camel, yak, horse, etc.). Additionally or alternatively, according to some embodiments, the milk component may include a non-dairy milk alternative, such as “vegan mylk”, “vegan milks”, or “milk alternatives”, etc. Optionally, the non-dairy milk may be made from oats, potatoes, tiger nut, soy, rice, hazelnut, hemp, macadamia, almond, peanut, grains, barley, quinoa, peas, coconut, or any combination thereof. Optionally, the non-dairy milk may comprise flours made from one or more of such ingredients. Optionally, the non-dairy milk may comprise treatment of one or more of such ingredients.

According to some embodiments, the cocoa-free chocolate composition may not comprise a dairy product from animal source.

As a further advantage, cocoa-free chocolate composition may be devoid of, or essentially devoid of, synthetic preservatives and/or all ingredients may be 100% natural. Optionally, all or some of the ingredients may be organically grown.

According to some embodiments, the cocoa-free chocolate composition may comprise less than about 30% wt, 25% wt, 20% wt, or 18% wt sugar. Each possibility is a separate embodiment.

According to some embodiments, the cocoa-free chocolate composition may comprise more than about 10% wt, 15% wt, or 20% wt mono-unsaturated fat. Each possibility is a separate embodiment.

Some more specific combinations of ingredients suitable for use with the cocoa-free chocolate of the invention are provided in the embodiments included below.

According to some embodiments, the cocoa-free chocolate composition may comprise about 30-50% wt shea butter, illipe butter and/or palm oil; about 8-40% wt carob powder; and about 0.5-15% wt roasted fermented barley. Each possibility is a separate embodiment.

According to some embodiments, the cocoa-free chocolate composition may further comprise about 14-35% wt white sugar; about 1-2.5% wt grape seeds; about 0.2-1% wt cherries or rose hips; about 0.2-1% wt sunflower lecithin; about 0.01-0.2% wt vanilla; about 0.5-0.8% wt malted barley; and/or about 4-7% wt tiger nut. Each possibility is a separate embodiment.

In some embodiments, the fermented cereal grain and the legume component are at a ratio of about 1:5-1:25 wt/wt in the cocoa-free chocolate composition. In some embodiments, the fermented cereal grain and the legume component are at a ratio of about 1:5-1:20 wt/wt, about 1:5-1:15 wt/wt, about 1:5-1:10 wt/wt, about 1:5-1:7 wt/wt, about 1:10-1:20 wt/wt, about 1:10-1:15 wt/wt, or about 1:15-1:20 wt/wt in the cocoa-free chocolate composition. Each possibility is a separate embodiment.

In some embodiments, the fermented barley and the carob are at a ratio of about 1:5-1:20 wt/wt in the cocoa-free chocolate composition. In some embodiments, the fermented barley and the carob are at a ratio of about 1:5-1:15 wt/wt, about 1:5-1:10 wt/wt, about 1:5-1:7 wt/wt, about 1:10-1:20 wt/wt, about 1:10-1:15 wt/wt, or about 1:15-1:20 wt/wt in the cocoa-free chocolate composition. Each possibility is a separate embodiment.

According to some embodiments, the cocoa-free chocolate compositions and products of the invention may be generally divided into “dark chocolate-like” compositions and products, and “milk chocolate-like” compositions and products. This division may be based on similarity in appearance (e.g., color) and taste (e.g. sweetness) to dark chocolate or to milk chocolate. Accordingly, the terms “dark chocolate” and “milk chocolate” as used herein with reference to the cocoa-free chocolate compositions and products of the invention relate to compositions and products resembling in appearance and taste dark chocolate and milk chocolate, respectively.

According to some embodiments, the cocoa-free chocolate composition may be a dark cocoa-free chocolate composition.

According to some embodiments, the dark cocoa-free chocolate composition may comprise about 30-50% wt shea butter, illipe butter and/or palm oil; about 15-40% wt carob powder; and about 1.5-5% wt roasted fermented barley. Each possibility is a separate embodiment.

According to some embodiments, the dark cocoa-free chocolate composition may further comprise about 14-35% wt white sugar; about 1-2.5% wt grape seeds; about 0.2-1% wt cherries or rose hips; about 0.2-1% wt sunflower lecithin; about 0.01-0.2% wt vanilla; about 0.5-0.8% wt malted barley; and/or about 4-7% wt tiger nut. Each possibility is a separate embodiment.

In some embodiments, the fermented cereal grain and the legume component are at a ratio of about 1:5-1:15 wt/wt or about 1:10 wt/wt in the dark cocoa-free chocolate composition. In some embodiments, the fermented cereal grain and the legume component are at a ratio of about 1:7-1:12 wt/wt, about 1:10-1:15 wt/wt, or about 1:5-1:10 wt/wt in the dark cocoa-free chocolate composition. Each possibility is a separate embodiment.

In some embodiments, the fermented barley and the carob are at a ratio of about 1:5-1:15 wt/wt or about 1:10 wt/wt in the dark cocoa-free chocolate composition. In some embodiments, the fermented barley and the carob are at a ratio of about 1:7-1:12 wt/wt, about 1:10-1:15 wt/wt, or about 1:5-1:10 wt/wt in the dark cocoa-free chocolate composition. Each possibility is a separate embodiment.

According to some embodiments, the cocoa-free chocolate composition may be a milk cocoa-free chocolate composition.

According to some embodiments, the milk cocoa-free chocolate composition may comprise about 30-50% wt shea butter, illipe butter and/or palm oil; about 15-40% wt carob powder; and about 0.5-3% wt roasted fermented barley. Each possibility is a separate embodiment.

According to some embodiments, the milk cocoa-free chocolate composition may further comprise about 14-35% wt white sugar; about 1-2.5% wt grape seeds; about 0.2-1% wt cherries or rose hips; about 0.2-1% wt sunflower lecithin; about 0.01-0.2% wt vanilla; about 0.6-0.8% wt malted barley; about 4-7% wt tiger nut; about 2-10% wt oat milk; and/or about 5-25% wt cow's milk powder. Each possibility is a separate embodiment.

In some embodiments, the fermented cereal grain and the legume component are at a ratio of about 1:15-1:25 wt/wt or about 1:20 wt/wt in the milk cocoa-free chocolate composition. In some embodiments, the fermented cereal grain and the legume component are at a ratio of about 1:17-1:22 wt/wt, about 1:20-1:25 wt/wt, or about 1:15-1:20 wt/wt in the milk cocoa-free chocolate composition. Each possibility is a separate embodiment.

In some embodiments, the fermented barley and the carob are at a ratio of about 1:15-1:25 wt/wt or about 1:20 wt/wt in the milk cocoa-free chocolate composition. In some embodiments, the fermented barley and the carob are at a ratio of about 1:17-1:22 wt/wt, about 1:20-1:25 wt/wt, or about 1:15-1:20 wt/wt in the milk cocoa-free chocolate composition. Each possibility is a separate embodiment.

During the process of preparing the cocoa-free chocolate composition, the ingredients are mixed and ground to produce fine particles.

According to some embodiments, the cocoa-free chocolate composition may comprise mostly small particles, generally under 20 microns or 15 microns.

According to some embodiments, the cocoa-free chocolate composition may not comprise particles larger than about 15 micron, 20 microns, 30 microns, 40 microns, 50 microns, 60 microns, or 70 microns. Each possibility is a separate embodiment. According to some embodiments, the cocoa-free chocolate composition may not comprise particles larger than about 70 microns.

According to some embodiments, the cocoa-free chocolate composition may comprise only particles with a size smaller than 30 microns, 25 microns, 20 microns, 15 microns.

According to some embodiments, at least 70%, 80%, 90%, 95%, or 99% of the particles in the cocoa-free chocolate composition may have a size smaller than about 40, 30 microns, 25 microns, 20 microns, or 15 microns. Each possibility is a separate embodiment. According to some embodiments, less than about 5%, 10%, 15%, 20%, or 30% of the particles in the cocoa-free chocolate composition may have a size larger than about 15 microns, 20 microns, 25 microns, or 30 microns. Each possibility is a separate embodiment.

According to some embodiments, the cocoa-free chocolate compositions described herein may be further used to make cocoa-free chocolate products. It is appreciated that the cocoa-free chocolate composition may also be a cocoa-free chocolate product, without the need for further processing. Additionally or alternatively, making cocoa-free chocolate products may involve tempering the composition and/or molding it into a desired shape, or melting the composition and, optionally, mixing it with further ingredients.

According to some embodiments, tempering may not be required. For example, when non-temper fats may be used in the composition, melting would be sufficient to facilitate further processing such as molding, and tempering is not required.

According to some embodiments, molding may not be required, e.g., if the composition is mixed with further ingredients such as, e.g., fruits, nuts, or granola, or used as a paste, spread, drink, topping, filling, etc.

According to some embodiments, there is provided a cocoa-free chocolate product prepared from the composition disclosed herein.

According to some embodiments, the cocoa-free chocolate product may be the cocoa-free chocolate composition. According to some embodiments, the cocoa-free chocolate product is produced from the cocoa-free chocolate composition by further processing, such as by tempering or melting the composition, and/or molding the tempered or melted composition into a desired shape or form.

According to some embodiments, the cocoa-free chocolate product may be in a solid form. According to some embodiments, the cocoa-free chocolate product may be in a liquid form.

According to some embodiments, the cocoa-free chocolate product may be a dark cocoa-free chocolate product. According to some embodiments, the cocoa-free chocolate product may be a milk chocolate cocoa-free chocolate product. According to some embodiments, the cocoa-free chocolate product may have various desired flavors or aromas which may be achieved by including certain ingredients. According to some embodiments, the cocoa-free chocolate product may have various desired flavors or aromas which may be achieved by preparing the cocoa-free chocolate composition by using certain conditions (such as certain fermentation and/or roasting conditions), as disclosed herein.

According to some embodiments, the cocoa-free chocolate product may be molded into any desired shape, such as a regular chocolate bar, a square, a ball, or a dome shape. According to some embodiments, the cocoa-free chocolate product may be used in any chocolate product such as pralines or truffles.

According to some embodiments, the cocoa-free chocolate product may further be embedded or included in chocolate-containing food products, such as candy bars and pastries. For example, the cocoa-free chocolate product may be used as topping for pastries, ice cream, Easter eggs, as an outer layer of a candy bar (e.g. similar to Daim bars, Reese's bar, Mars bar, Snickers, Loacker, etc.), as a filling, such as in croissants, for baking, such as in chocolate chip cookies, or by mixing with fruits, nuts, granola, cornflakes, etc., to create clusters (e.g. granola clusters or nuts clusters). According to some embodiments, the cocoa-free chocolate product may be used as a drink, or as a spread.

According to some embodiments, the cocoa-free chocolate product may be in the form of a chocolate candy, a chocolate bar, a chocolate paste, a chocolate spread, a chocolate drink, a chocolate topping, or a chocolate filling.

In some embodiments, the cocoa-free chocolate product is in the form of a chocolate bar. In some embodiments, the chocolate bar has characteristics similar to those of a cacao-containing chocolate bar (herein referred to as standard, or reference, chocolate).

In some embodiments, the cocoa-free chocolate bar has a hardness value of about 300-500, 350-450, or 380-450 gram-force (1000 gram-force=9.81 Newtons).

In some embodiments, the cocoa-free chocolate bar has a plastic viscosity value of about 500-1600, 600-1600, or 700-1600 cP.

In some embodiments, the cocoa-free chocolate bar has a yield stress value of about 0-200, 10-200, 20-200, 30-200, 40-200, 20-150, or 30-150 dyn/cm².

In some embodiments, the cocoa-free chocolate bar has a contraction value of about 3%-5%, 3%-4.5%, or 3.5%-4.5%.

In some embodiments, there is provided a method for the preparation of a cocoa-free chocolate composition or product, the method comprising:
fermenting a cereal grain; and
mixing the fermented cereal grain with at least one non-animal fat and at least one
legume component to form a cocoa-free chocolate composition comprising:
   5-65% % wt of the at least one non-animal fat;
   5-40% wt of the at least one legume component; and
   0.1-25% wt of the roasted cereal grain.

It is appreciated that since the method is for making the cocoa-free compositions and products described above, the definitions and embodiments included above, with reference to the compositions and products, also apply here. Nevertheless, some specific embodiments are also included below.

According to some embodiments, the method comprises melting the at least one non-animal fat prior to mixing with the roasted fermented cereal grain the legume component. According to some embodiments, the melting is performed at a temperature of about 35-45° C.

According to some embodiments, the method further comprises adding at least one sweetener and/or at least one emulsifier.

According to some embodiments, the at least one sweetener is added at an amount of about 0.1-45% wt of the composition.

According to some embodiments, the at least one emulsifier is added at an amount of about 0.1-0.5% wt of the composition.

According to some embodiments, the fermenting may comprise incubating the cereal grain with at least one microorganism under conditions suitable for fermentation of the cereal grain. The at least one microorganism may be in the form of a starter culture, such as a spore.

According to some embodiments, the fermenting may be performed by incubating the cereal grain with at least one microorganism selected from the group comprising of Aspergillus oryzae, Bacillus subtilis, Aspergillus sojae, Rhizopus oligosporus, Rhizopus oryzae, Neurospora intermedia var. Oncomensis, Aspergillus luchuensis, Lactococcus lactis subsp, B, Bacillus sp., Bacillus licheniformis, Bacillus giant, Bacillus pumilus, Bacillus amylolitica, Bacillus methylotrophic, Bacillus proteolysaccharide, Bacillus brevis, Laceyella Sacchari, Corynebacterium glutamicum, Saccharomyces cerevisiae, Candida krusei, Candida parapsilosis, Candida glabrata, Candida tropicalis, Candida guillermondii, Candida rugosa, Pichia kudriavzevii, and any combination thereof. Each possibility is a separate embodiment.

According to some embodiments, the at least one microorganism may be Aspergillus oryzae and/or Bacillus subtilis.

According to some embodiments, the fermenting may be conducted by incubating the cereal grain with more than one microorganism. According to some embodiments, the fermenting may be repeated with different batches of cereal grains, or with different cereal grains, and the fermented cereal grains may be combined after the fermentation. According to some embodiments, the fermenting may be conducted several times (possibly in parallel) with different batches of cereal grains, or with different cereal grains, by using different microorganisms or by incubating under different conditions, and the fermented cereal grains may be combined after the fermentation. For example, barley may be fermented in parallel with Aspergillus oryzae, and with Bacillus subtilis, and the two fermented barleys are combined.

Accordingly, in some embodiments, the fermenting a cereal grain comprises fermenting more than once, such as two or three times, each fermenting being conducted by incubating a cereal grain with different microorganisms, and combining the fermented cereal grains.

According to some embodiments, the conditions for the fermentation may include a selected temperature and a selected relative humidity (RH) for a desired amount of time. For example, fermentation conditions may include incubation at a temperature of about 28-45° C. with RH of about 35-95% for a time length of about 36-48 hours.

According to some embodiments, the method further comprises roasting the fermented cereal grain prior to the mixing. According to some embodiments, roasting of the fermented cereal grains may be performed at a temperature of about 30-100° C., about 30-80° C., about 35-70° C., about 30-65° C., about 40-65° C., about 40-60° C., about 40-55° C., about 45-60° C., or any other sub-range within the range between about 30-100° C. Each possibility is a separate embodiment.

According to some embodiments, the roasting of the fermented cereal grains may be performed for a length of time of several days, such as about 3, 5, 10, 15, or 30 days, or for several months, such as 2, 3, 4, 5, or 6 months, or for any time length with in the range of several days to several months, such as from about 3 days to about 6 months. Each possibility is a separate embodiment.

According to some embodiments, roasting the cereal grains may result in the roasted cereal grains being in a paste form.

The roasting, similar to the fermenting, may be conducted several times (with separate batches of fermented grains, e.g. in parallel) at different temperatures/for different lengths of time, and combining the roasted fermented cereal grains. Roasting under different conditions may give rise to different flavors/aromas, and therefore combining fermented cereal grains roasted under different conditions may be done in order to achieve a certain flavor/aroma profiles.

According to some embodiments, the cereal grains may be soaked and/or steamed prior to fermentation.

According to some embodiments, the cereal grains may be pasteurized following fermentation. For example, pasteurization may be conducted by incubation at a temperature sufficient to kill pathogenic microorganisms. For example, a temperature of above 62.7° C. to kill Bacillus cereus.

According to some embodiments, the pasteurization may be followed by rapid chilling, to avoid and/or minimize the growth of pathogenic microorganisms.

According to some embodiments, the legume component may already be roasted (pre-roasted). According to some embodiments, the method may further comprise roasting of the legume component.

According to some embodiments, roasting of the legume component (such as, carob powder) may be conducted at a temperature of about 75-250° C., about 100-200° C., about 120-150° C., or any other sub-range within the range between about 35-100° C. Each possibility is a separate embodiment.

According to some embodiments, roasting the legume component may be conducted for a length of time of about 1 minute to 2 hours, about 3 minutes to 1 hour, about 3 minutes to about 30 minutes, or any other sub-range within the range between about 1 minutes to 2 hours. Each possibility is a separate embodiment.

According to some embodiments, roasting the legume component, similar to roasting the cereal grains, may be conducted several times (with separate batches of legumes, e.g. in parallel) at different temperatures/for different lengths of time, and combining the roasted legume components. Roasting under different conditions may give rise to different flavors/aromas, and therefore combining legume components roasted under different conditions may be done in order to achieve a certain flavor/aroma profiles.

According to some embodiments, mixing of the ingredients may further involve grinding, in order to ensure a small particle size, such as a particle size of below 20 microns, or below 15 microns. According to some embodiments, the mixing and grinding may be conducted by any standard equipment, such as by a standard chocolate melanger or grinder. Non-limiting examples for a standard grinder include a ball mill, a roller mill, or a stone grinder. According to some embodiments, the particle size may be measured by any suitable method, such as by a grindometer.

According to some embodiments, following the grinding, the cocoa-free chocolate composition may not comprise particles larger than 70 microns. According to some embodiments, at least about 70%, 80%, 90%, 95%, or 99% of the particles in the composition may be smaller than about 40 microns, 30 microns, 25 microns, 20 microns, or 15 microns. Each possibility is a separate embodiment.

According to some embodiments, the method may further comprise adding additional ingredients to the composition, such as at least one of a thickener, a binder, a disintegrant, a stabilizer, a flavor enhancer, a flavor agent, an aroma agent, a texture agent, a pH modifier, or a combination thereof. Each possibility is a separate embodiment.

According to some embodiments, the method may further comprise tempering the cocoa-free chocolate composition, as explained above. According to some embodiments, the method does not comprise tempering of the cocoa-free chocolate composition. According to some embodiments, non-temper fats may be used in the composition, and therefor tempering may not be required by the method.

According to some embodiments, the method may comprise molding the tempered cocoa-free chocolate composition into a desired form.

According to some embodiments, tempering may be performed by heating the cocoa-free chocolate composition to a temperature of about 20-55° C., about 20-50° C., about 20-45° C., about 25-55° C., about 25-50° C., about 25-40° C., about 25-35° C., about 30-55° C., about 35-55° C., about 40-55° C., about 45-55° C., or about 26-41° C. Each possibility is a separate embodiment.

According to some embodiments, tempering may be performed by heating the cocoa-free chocolate composition as disclosed above, and then cooling to a temperature of about 20-45° C., about 20-35° C., about 25-35° C., or about 25-30° C. Each possibility is a separate embodiment. According to some embodiments, due to the tempering, the cocoa-free chocolate product may be configured to melt in the mouth.

According to some embodiments, the cocoa-free chocolate product may be configured to have a mouth feel similar to conventional chocolate. According to some embodiments, due to the tempering, the cocoa-free chocolate product may be configured to snap on breaking.

Reference is now made to the figures.

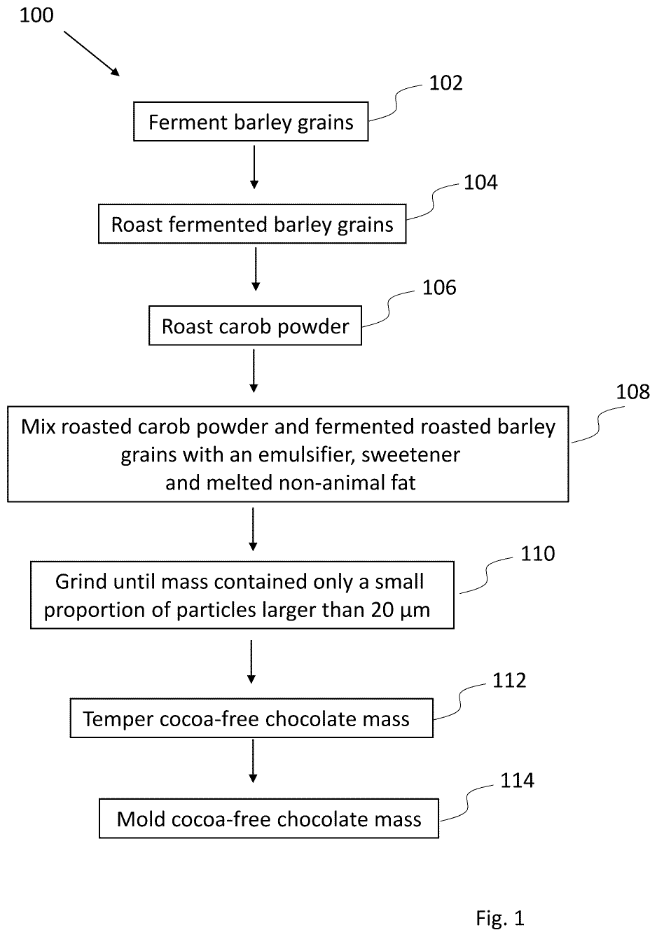

FIG. 1 is a flowchart of steps in an exemplary process for preparing a cocoa-free chocolate product, according to some embodiments. For example, in the process 100 barley grains are fermented 102, and then roasted 104. Carob powder is roasted 106. The roasted fermented barley grains and roasted carob powder are mixed with an emulsifier, sweetener and melted non-animal fat 108, and ground 110 to produce a cocoa-free chocolate composition, which is tempered 112, molded 114, and cooled to room temperature. Optionally, additional ingredients may be added to the cocoa-free chocolate composition before or after tempering.

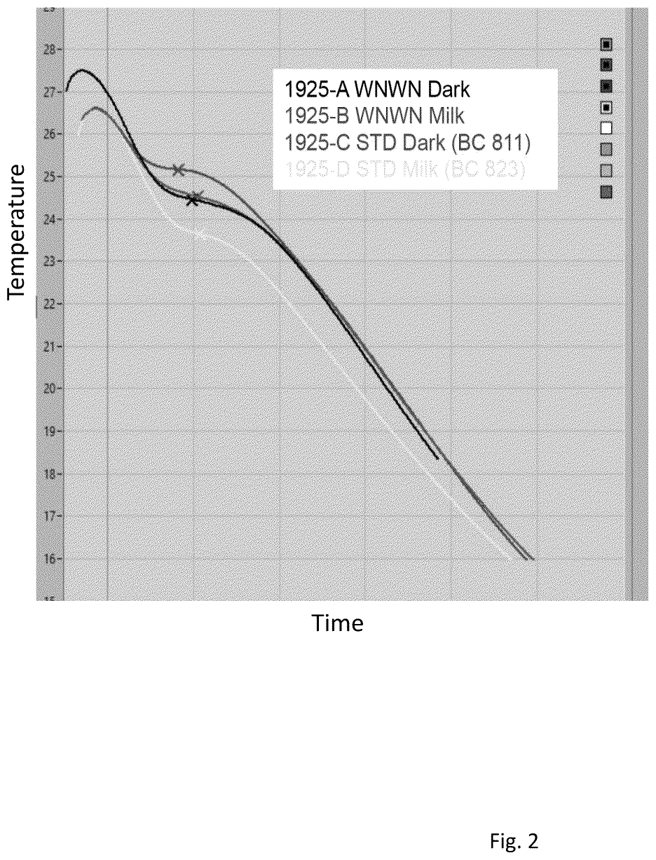

FIGS. 2-8 present comparisons of the physical characteristics of the cocoa-free chocolate of the invention, including temper curve, flow, hardness, viscosity, yield stress, stability, and contraction, with those of standard (cocoa-containing) chocolate.

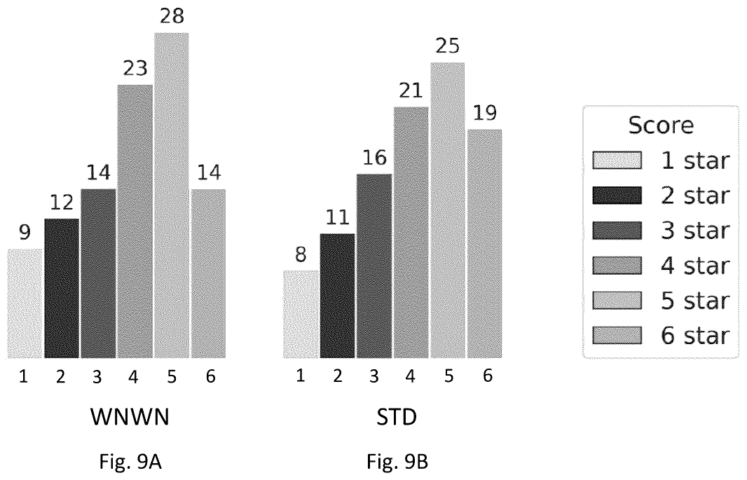

FIGS. 9-12 present results of sensory analyses of the cocoa-free chocolate of the invention in comparison with standard chocolate.

As used herein, the term “cocoa-free”, used with reference to the compositions and products of the invention, encompasses both cocoa-free and cacao-free compositions and products, and refers to compositions or products which are essentially devoid of cacao bean- or cacao seed-derived ingredients, such as cacao powder, cocoa powder, cocoa solids, or cocoa butter.

According to some embodiments, the term “essentially devoid of” may refer to the stated material being either entirely absent or present in a residual amount, such as less than 0.05%, less than 0.1%, less than 0.5% or less than 1%. Each possibility is a separate embodiment.

The term “a” and “an” refers to one or to more than one (i.e., to at least one) of the grammatical object of the article. By way of example, “an element” means one element or more than one element.

The term “about” when referring to a measurable value such as an amount, a temporal duration, and the like, is meant to encompass variations of ±20% or in some instances ±10%, or in some instances ±5%, or in some instances ±1%, or in some instances ±0.1% from the specified value, as such variations are appropriate to perform the disclosed methods.

As used herein, the denotation “% w/w” or “% wt” refers to weight percent of the subject of the statement relative to the total weight of the composition.

As used herein, “optional” or “optionally” means that the subsequently described event or circumstance does or does not occur, and that the description includes instances where said event or circumstance occurs and instances where it does not.

As used herein, the term “essentially” may refer to a deviation from a stated amount by ±1%, ±2% or ±5%. Each possibility is a separate embodiment.

As used herein, the term “comprising” is synonymous with the terms “including,” “containing,” or “characterized by,” and is inclusive or open-ended i.e., does not exclude additional, unrecited elements. According to some embodiments, the term comprising may be replaced with the term may be replaced with the term “consisting of” which excludes any element, step, or ingredient not specified in the claim or with the term “consisting essentially of” which limits the scope of a claim to the specified materials or steps “and those that do not materially affect the basic and novel characteristics” of the claimed invention.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

### Example 1: Basic Composition and Process for the Preparation of Cocoa-Free Chocolate Products

The ingredients of the composition are set forth in Table 1 below.

TABLE 1

| | Amount (g) | % wt composition |
|---|---|---|
| Vegetable fat (e.g. shea butter, | 776 | 44.1 |
| illipe butter and/or palm oil) | | |
| Carob powder | 488 | 27.8 |
| Roasted fermented barley paste | 224 | 12.7 |
| White sugar | 258 | 14.7 |
| Sunflower lecithin | 12 | 0.7 |
| Total | | 100 |

The roasted fermented barley paste was prepared according to the following process:
1. Barley grains were soaked in water for between 2-4 hours.
2. The grains were steamed for between 5-50 minutes at a temperature above 90° C. and high humidity (e.g., more than a relative humidity of 65% RH).
3. For fermentation, the grains were inoculated with a starter culture of microorganisms, such as mold spores, e.g., of Aspergillus oryzae. Alternatively, grains may be inoculated with other microorganisms (fungi or bacteria), one example being Bacillus subtilis.
4. The grains and microorganisms were incubated in an incubator that has the capacity to control air flow, temperature, and humidity, for between 36-48 hours within a temperature range between 28-45° C. and a relative humidity of between 35-95% RH. Even growth was ensured by monitoring the temperature, humidity, and access to oxygen.
5. The fermented grains were pasteurized at a temperature above the kill temperature for pathogenic microorganisms. For example, for the case of Bacillus cereus the kill temperature is 62.7° C.
6. The pasteurized fermented grains were rapidly chilled in a blast chiller to avoid and/or minimize the growth of pathogenic microbes.
7. The fermented grains were transferred into postprocessing vessels made of food grade materials able to exclude as much oxygen as possible, and heated to about 30° C.-65° C. in the absence of oxygen for roasting until enzymatic reactions took place and the grains were partially liquified and assumed a paste form. The roasting process was associated with a change of color (to darker colors e.g., brown/black) and the development of new aroma and taste compounds.
8. Optionally, the above process was conducted multiple times, each time using different microorganisms for fermentation, and different roasting temperatures and times to generate a variety of aromas and flavors, and the resulting pastes were combined to form desired flavor profiles.

The carob powder was treated according to the following process:
1. Carob powder was roasted to achieve desired flavors and aromas.
2. Roasting was conducted at temperatures of about 100-200° C. for about 3-30 minutes.
3. Optionally, powders were roasted at different temperatures for different amounts of times to achieve certain flavors/aromas, and combined to achieved a desired combination.

A cocoa-free chocolate mixture was prepared by mixing and grinding the roasted carob powder and the roasted fermented barley paste with an emulsifier (here sunflower lecithin), sweetener (here white sugar), and melted plant-based fat (here shea butter, illipe butter and/or palm oil), until the mixture contained only a small proportion of particles larger than 15 microns, 20 microns or 30 microns and no coarser particles larger than 70 microns.

For molding into a desired product, the cocoa-free chocolate mixture was tempered by heating the mixture to between 40-55° C., and cooling to between 25 and 35° C.

Following tempering, the cocoa-free chocolate mixture was molded as required and allowed to cool to room temperature.

### Example 2: Composition Suitable for the Preparation of Cocoa-Free Chocolate Covered Hazelnut Caramel Confectionery Bar

The ingredients of the composition are set forth in Table 2 below.

TABLE 2

| | Amount (g) | % wt composition |
|---|---|---|
| Vegetable fat (e.g. shea butter, | 163.5 | 33.2 |
| illipe butter and/or palm oil) | | |
| Carob powder | 45.7 | 9.3 |
| Roasted fermented barley paste | 6.7 | 1.4 |
| Sugars | 159.5 | 32.5 |
| Sunflower lecithin | 1.0 | 0.2 |
| Salt | 1.0 | 0.21 |
| Oat milk | 25 | 5.1 |
| White wine vinegar | 5 | 1.0 |
| Hazelnuts | 83 | 16.9 |
| Total | | 100 |

A cocoa-free chocolate composition was prepared by the process described in Example 1, and following tempering, roasted and salted hazelnuts combined with a hot caramel were added to the tempered cocoa-free chocolate mixture.

### Example 3: Composition for the Preparation of Flavored Cocoa-Free Chocolate

The ingredients of the composition are set forth in Table 3 below.

TABLE 3

| | Amount (g) | % wt composition |
|---|---|---|
| Vegetable fat (e.g. shea butter, | 37.75 | 37.75 |
| illipe butter and/or palm oil) | | |
| Carob powder | 31.7 | 31.7 |
| Roasted fermented barley paste | 4.7 | 4.7 |
| Sugar | 16.2 | 16.2 |
| Sunflower lecithin | 0.7 | 0.7 |
| Salt | 0.05 | 0.05 |
| Grape seeds | 2.4 | 2.4 |
| Apricot kernels | 0.5 | 0.5 |
| Oat husks | 2.1 | 2.1 |
| Rose hip | 0.3 | 0.3 |
| Fermented soybeans | 3.6 | 3.6 |
| Total | | 100 |

A cocoa-free chocolate composition and product were prepared from the above ingredients by a process similar to the process described in Example 1.

### Example 4: Cocoa-Free Dark Chocolate Composition

The ingredients of the composition are set forth in Table 4 below.

TABLE 4

| Ingredient | Amount (g) | Composition (% wt) |
|---|---|---|
| Vegetable fat (e.g. shea butter, | 1170 | 39 |
| illipe butter and/or palm oil) | | |
| Carob powder | 555.51 | 18.52 |
| Roasted fermented barley paste | 71.2 | 2.37 |
| Sugar | 900 | 30 |
| Lecithin | 6 | 0.2 |
| Salt | 0.6 | 0.02 |
| Tiger Nut | 150 | 5 |
| Grape Seed | 34.2 | 1.14 |
| Sunflower Seeds | 75 | 2.5 |
| Cherries | 12 | 0.4 |
| Vanilla | 6 | 0.2 |
| Malted barley | 19.5 | 0.65 |
| Total | 3000 | 100 |

The sunflower seeds were defatted and the cherries were freeze-dried.

A cocoa-free dark chocolate composition and chocolate bar were prepared from the above ingredients by a process similar to that described in Example 1.

### Example 5: Cocoa-Free Vegan Milk Chocolate Composition

The ingredients of the composition are set forth in Table 5 below.

TABLE 5

| Ingredient | Amount (g) | Composition (% wt) |
|---|---|---|
| Vegetable fat (e.g. shea butter, | 1200 | 40 |
| illipe butter and/or palm oil) | | |
| Carob powder | 528 | 17.6 |
| Roasted fermented barley paste | 29.03 | 0.97 |
| Sugar | 787.5 | 26.25 |
| Lecithin | 6 | 0.2 |
| Salt | 1.54 | 0.05 |
| Tiger Nut | 192.2 | 6.41 |
| Grape Seed | 31.02 | 1.03 |
| Sunflower Seeds | 75 | 2.5 |
| Cherries | 6 | 0.2 |
| Vanilla | 6 | 0.2 |
| Malted barley | 22.4 | 0.75 |
| Oats milk | 115.3 | 3.84 |
| Total | 3000 | 100 |

The sunflower seeds were defatted and the cherries were freeze-dried.

A cocoa-free vegan milk chocolate composition and chocolate bars were prepared from the above ingredients by a process similar to that described in Example 1.

Cocoa-free dark chocolate and cocoa-free milk chocolate bars prepared based on the compositions presented in Tables 4 and 5 were used in the below examples, which tested features including quality and taste of the cocoa-free chocolates.

### Example 6: Temper Curves

Temper curves of 4 samples were measured on a TRICOR Temper Meter (see FIG. 2, showing the change in chocolate temperature (Y-axis) over time (X-axis)). The 4 samples were WNWN Dark (cocoa-free dark chocolate), WNWN Milk (cocoa-free milk chocolate), reference cocoa dark chocolate (STD Dark), and reference cocoa milk chocolate (STD Milk). As can be seen from FIG. 2, the temper curves of all the samples were similar.

### Example 7: Cup Flow Test

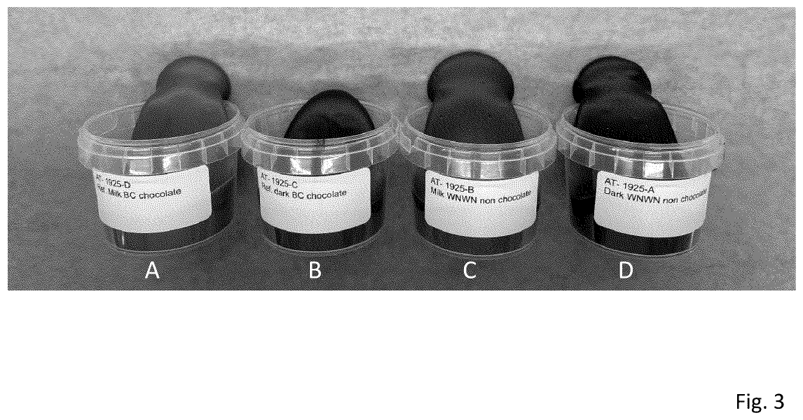

Cup flow tests were conducted on 4 samples to measure chocolate flow by heating to 40-45° C. and letting melted chocolate flow from the cups (see FIG. 3). The 4 samples were A) reference cocoa milk chocolate (STD Milk), B) reference cocoa dark chocolate (STD Dark), C) WNWN Milk (cocoa-free milk chocolate), and D) WNWN Dark (cocoa-free dark chocolate). As can be seen from FIG. 3, the flow properties of the cocoa-free milk chocolate and the cocoa-free dark chocolate were similar to those of the reference cocoa milk chocolate.

### Example 8: Hardness

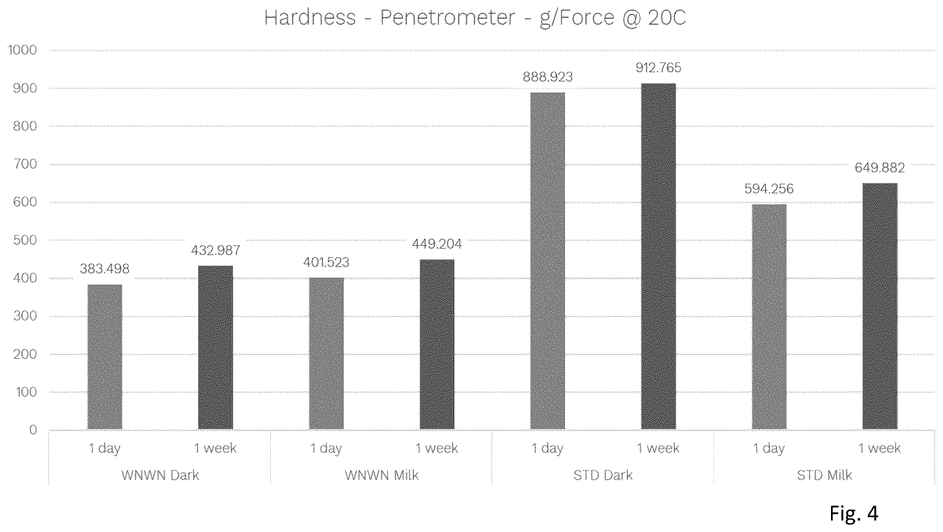

Comparative hardness tests were performed using a penetrometer on 4 samples after 1 day (left each pair) and after 1 week (right each pair) at 20° (see FIG. 4). The 4 samples were (left to right): WNWN Dark (cocoa-free dark chocolate), WNWN Milk (cocoa-free milk chocolate), STD Dark (reference cocoa dark chocolate), and STD Milk (reference cocoa milk chocolate). In all cases, the hardness of the samples increased after 1 week. Hardness of the WNWN samples was between 380 and 450 gram-force or about 3.73 and 4.41 Newtons (1000 gram-force=9.81 Newtons).

### Example 9: Viscosity and Yield Stress

Plastic viscosity (PV) is measured in cP (centipoise), and is a function of the sheer stress required to maintain constant flow. In general, PV determines how well the chocolate will flow into a mold.

Yield stress is measured in dyn/cm², and is the sheer stress required to initiate fluid flow, and relates to the coating or decorating characteristics, such as thickness. In general, higher yield stress value leads to a product which resists flow e.g., chocolate drops.

In utilizing yield value and plastic viscosity, a general guideline for producing chocolate products can be created.

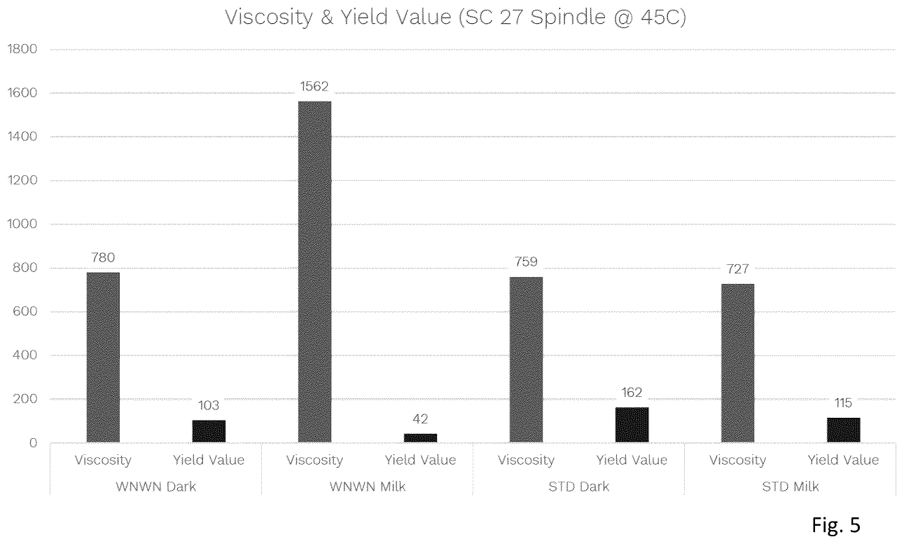

FIG. 5 is a comparison of viscosity (light blue, left each pair) and yield stress (dark blue, right each pair) of 4 samples performed on a SC spindle at 45° C. The 4 samples were (left to right): WNWN Dark (cocoa-free dark chocolate), WNWN Milk (cocoa-free milk chocolate), STD Dark (reference cocoa dark chocolate), and STD Milk (reference cocoa milk chocolate).

The measured values fall within expected ranges for standard cocoa chocolates, namely yield stress values of between 0 and 500 dyn/cm², and PV of 0-1500 centipoise. More specifically, the viscosity values were: for the WNWN dark chocolate—780 cP, and for the milk chocolate—1562 cP; and the yield stress values were: for the WNWN dark chocolate—102 dyn/cm², and for the milk chocolate—42 dyn/cm².

### Example 10: Cyclical Shelf-Life Test

Chocolate bloom is either of two types of whitish coating that can appear on the surface of chocolate: fat bloom, caused by changes in the fat crystals in the chocolate; and sugar bloom, due to crystals formed by the action of moisture on the sugar. While chocolate that has bloomed is still safe to eat, it may have an unappetizing appearance and surface texture and is not recommended for sale.

On a scale of 1 to 10, higher numbers indicate greater stability, while lower numbers indicate lower stability (more signs of bloom defects).

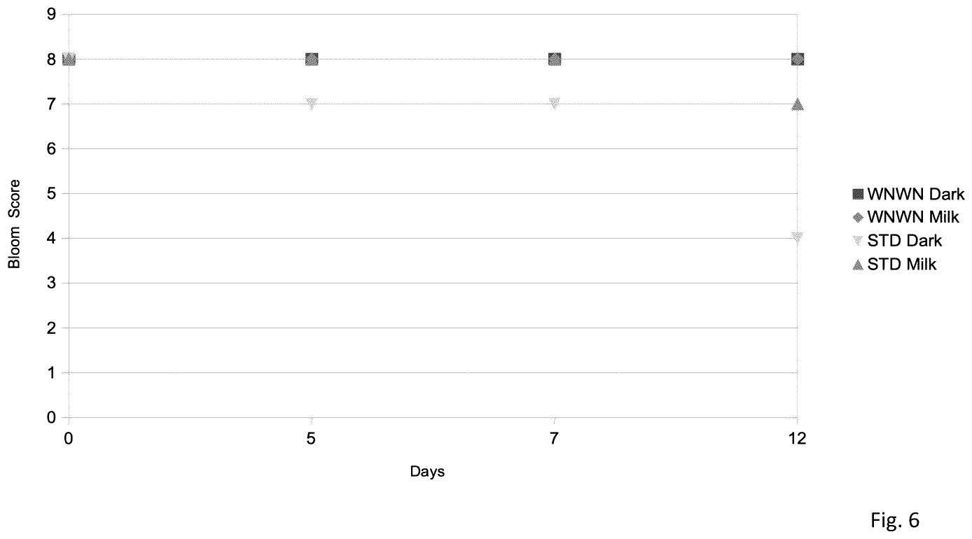

Comparison of the shelf-life stability of 4 samples cycling the storage temperature from 25° C. to 31° C. over a period of 2 weeks (see FIG. 6). The 4 samples were WNWN Dark (cocoa-free dark chocolate), WNWN Milk (cocoa-free milk chocolate), STD Dark (reference cocoa dark chocolate), and STD Milk (reference cocoa milk chocolate).

The results show that at 2 weeks, the cocoa-free chocolate was more bloom stable than conventional cocoa chocolate, and received a score of 8 throughout the two weeks. In contrast, the standard chocolate started with a score of 8, which gradually dropped to 7 for the milk chocolate and to a score of 4 for the dark chocolate by the end of the two weeks. A score of 8 means a nice gloss, while a score of 7 means that the product was less glossy than a dark chocolate tablet, and a score of 4 means that a very weak bloom appeared.

### Example 11: Fatty Acid Composition

The fatty acid composition of various WNWN tempered cocoa-free chocolate samples was compared with that of conventional tempered cocoa-containing chocolate (Table 6). The cocoa-free chocolate samples had similar fatty acid compositions to the cocoa-containing chocolate, however, the level of mono-unsaturated fats and of total fats was higher in the WNWN product than in the reference chocolates. Additionally, the WNWN products had a lower sugar composition than the reference chocolates. The cocoa-free chocolate systems were shown to be temper systems similar to cocoa-containing chocolate.

TABLE 6

| | Fatty acid (FA) content (% total mass) | | | | | |
|---|---|---|---|---|---|---|
| | | Mono- | Poly- | | | |
| | Sat. | Unsat. | Unsat. | Trans | % of Total mass | |
| Source | FA | FA | FA | FA | Fat | Sugar |
| WNWN | 25.3 | 20.1 | 2.5 | 0.0 | 48.1 | 19.1 |
| WNWN | 25.0 | 19.9 | 2.5 | 0.0 | 47.6 | 16 |
| WNWN | 25.2 | 19.8 | 2.5 | 0.0 | 47.6 | 16 |
| WNWN | 24.1 | 19.1 | 2.0 | 0.5 | 47.6 | 16 |
| WNWN | 23.7 | 19.4 | 2.1 | 0.5 | 47.6 | 16 |
| WNWN | 29.5 | 16.7 | 1.4 | 0.5 | 47.6 | 16 |
| STD | 25.0 | 14.5 | 2.5 | 0 | 42 | 29 |
| STD | 26.0 | 14.5 | 2.5 | 0 | 43 | 27 |
| STD | 22.0 | 12.5 | 2.5 | 0 | 37 | 43 |

### Example 12: Dark and Milk Cocoa-Free Chocolate Compositions

TABLE 7

Name

| | Dark: | Milk: |
|---|---|---|
| | WNWN1/2/3 | WNWN4 |
| | (#361/3/4) | (#366) |
| Ingredient | % wt | % wt |
| Vegetable fat | 48 | 47 |
| Carob powder | 32 | 17 |
| Roasted fermented barley | 3 | 1 |
| Sugar | 16 | 19 |
| Lecithin | 1 | 0 |
| Salt | 0 | 0 |
| Grape seed | 1 | 0 |
| Vanilla | 0 | 0 |
| Malted barley | 0 | 0 |
| Cow's Milk powder | 0 | 15 |

The vegetable fat comprised slightly different combinations of shea butter, illipe butter and/or palm oil (different between WNWN1, 2, and 3).

Cocoa-free dark or milk chocolate compositions and bars were prepared from the above ingredients by a process similar to that described in Example 1. The chocolate bars prepared were used in the below experiments.

### Example 13: Contraction

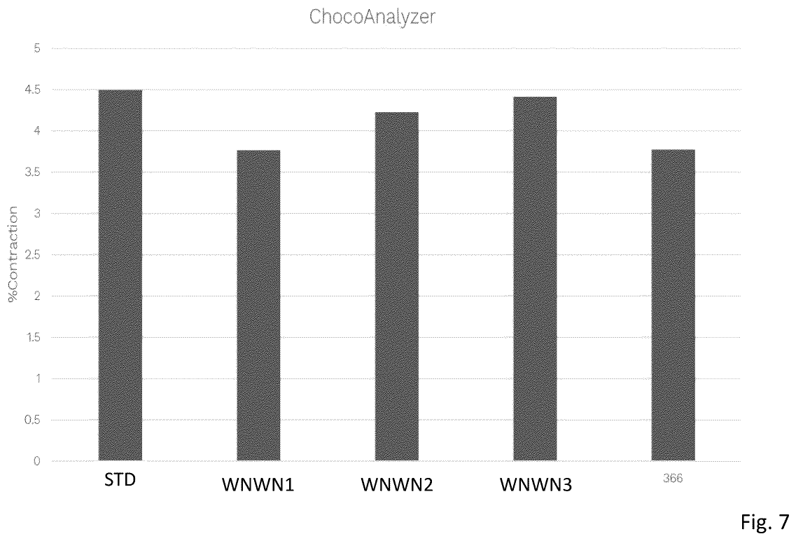

Contraction behavior of cocoa-free chocolate samples (WNWN1, WNWN2, WNWN3, WNWN4, bars 2-5 from left, respectively) versus a conventional cocoa-containing chocolate (STD, first bar from left) was measured on an Aasted ChocoAnalyzer. FIG. 7 and Table 8 show the result of the contraction test.

TABLE 8

| ChocoAnalyzer | Value (%) |
|---|---|
| STD | 4.49 |
| WNWN1 | 3.76 |
| WNWN2 | 4.22 |
| WNWN3 | 4.42 |
| WNWN4 | 3.77 |

Contraction values between 3.2-4 were considered to be similar to the conventional cocoa-containing dark chocolate. The contraction values for the WNWN samples were around 3.5%-4.5%, while the standard chocolate had the highest contraction value, of 4.5%.

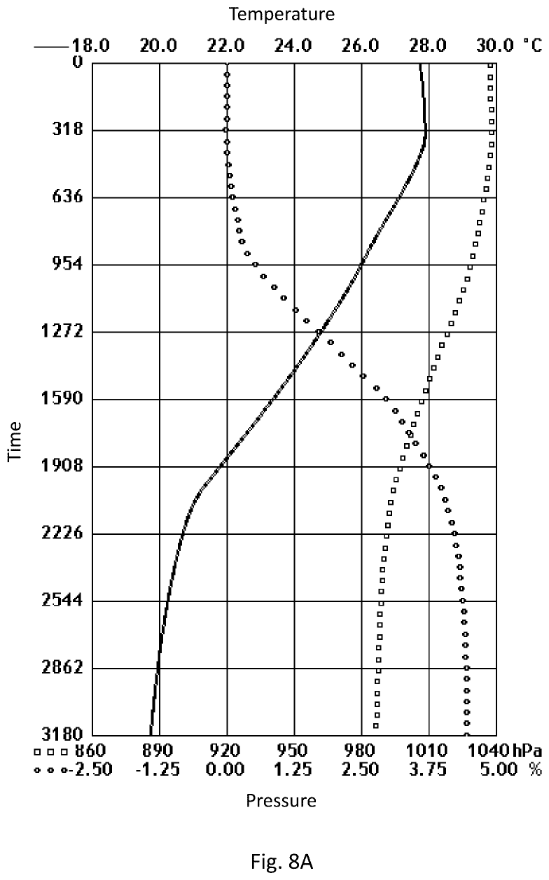

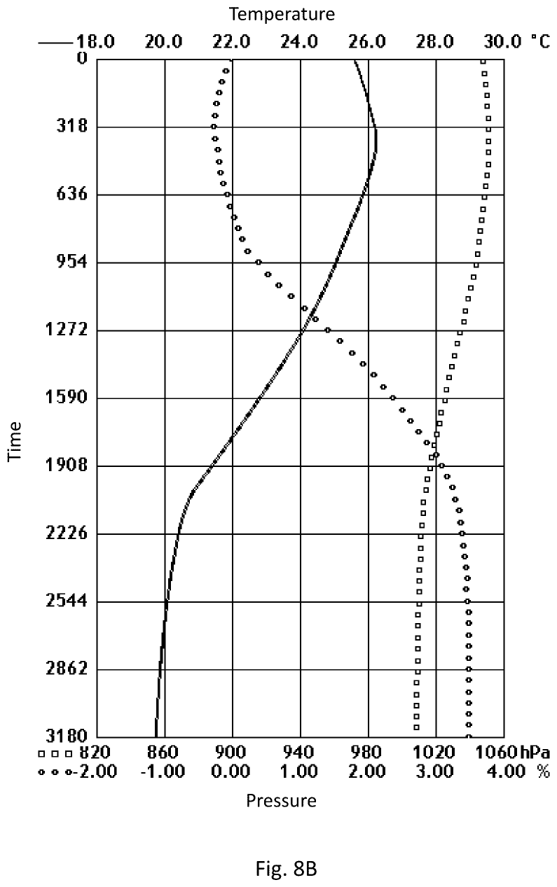

Additionally, FIG. 8A and FIG. 8B are charts showing raw contraction data from an Aasted ChocoAnalyzer machine for a sample of conventional cocoa-containing dark chocolate (STD) compared to a sample of cocoa-free dark chocolate (WNWN1).

All the contraction values of the cocoa-free dark chocolate samples were within the expected range, and were consistent with the behavior of conventional cocoa-containing dark chocolate.

### Example 14: Nutritional Values

Comparison of the nutritional values of cocoa-free chocolate (WNWN) were compared to other chocolates including cheap milk chocolate (Land), premium dark milk (Green & Blacks), and dairy milk chocolate (Cadbury's) (see Table 9). It was found that the cocoa-free chocolate had a similar calorie density, total carbohydrates, total sugars and total fat content as conventional cocoa-containing chocolate. Additionally, it was found that the cocoa-free chocolate was higher in dietary fiber and lower in saturated fats than the reference chocolates.

TABLE 9

| | | Green & | | | |
|---|---|---|---|---|---|
| Brand | WNWN | Blacks | Land | Cadbury's | Units |
| Chocolate | “Dark” | Organic dark | Malt dark | Dairy milk | |
| Cacao solids % | 55 | 70 | 65 | 20 | % |
| (or equivalent | | | | | |
| Energy | 585 | 580 | 538 | 534 | Kcal/100 g |
| Energy | 2421 | 2406 | 2235 | 2232 | kJ/100 g |
| Carbohydrates | 33 | 36 | 49 | 57 | g/100 g |
| Total sugars | 27 | 29 | 27 | 56 | g/100 g |
| Total fat | 46 | 42 | 42 | 30 | g/100 g |
| Saturated fat | 20 | 25 | 25 | 18 | g/100 g |
| Dietary fiber | 13.1 | 10 | 10.3 | 2.1 | g/100 g |
| Sodium as salt | <0.125 | <0.01 | 0.02 | 0.14 | g/100 g |
| Total protein | 2 | 9.1 | 6.1 | 7.3 | g/100 g |

### Example 15: Sensory Analysis

Sensory analysis study was carried out on 159 test subjects throughout Britain, of which 88 (55%) were female and 71 (45%) were male. The test consisted of 4 samples and included 200 tasting sets with 636 responses and 116,480 data points. The study was carried out by an independent testing company (TestBuds.io). Test subjects were given 4 samples to taste in a blind study: 3 cocoa-free chocolate samples and 1 conventional cocoa-containing chocolate.

All questions were scored numerically on a scale from 1 to 6 stars, where 1 star was designated as awful, and 6 stars were designated incredible. “Likes” or “top scores” included 5 and 6 stars only. This numerical system had the advantages of having no mid-point, so the test subjects could not sit on the fence, each score relates to a clearly defined position, and the scoring system was the same for all products tested. The scores were then averaged to provide an overall score for each question.

FIGS. 9A and 9B are charts showing the score breakdown of the overall score of conventional cocoa-containing chocolate (STD) and cocoa-free chocolate (WNWN). The cocoa-free chocolate (WNWN) had an overall score of 3.90 compared to cocoa-containing chocolate (STD) which had an overall score of 4.04. Therefore, both products had similar overall scores, indicating that the cocoa-free chocolate was very similar to the cocoa-containing chocolate.

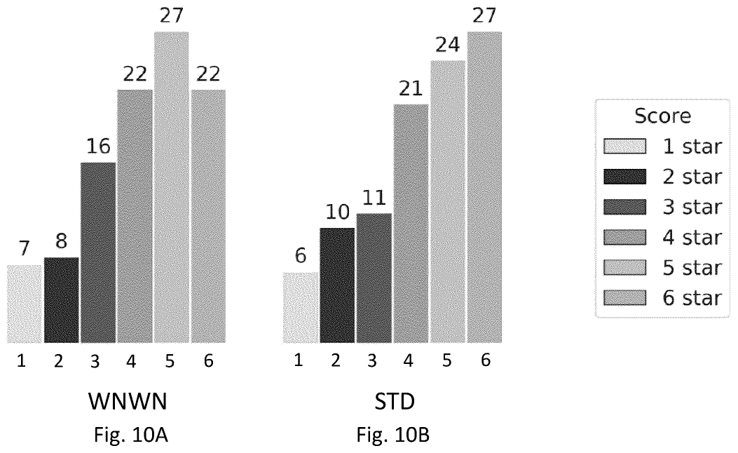

FIGS. 10A and 10B are charts showing the score breakdown of the closeness to chocolate score of conventional cocoa-containing chocolate (STD) and cocoa-free chocolate (WNWN). The cocoa-free chocolate (WNWN) had an overall closeness score of 4.19 compared to cocoa-containing chocolate (STD) which had an overall closeness score of 4.28. Therefore, the cocoa-free chocolate was found to be very similar to the cocoa-containing chocolate.

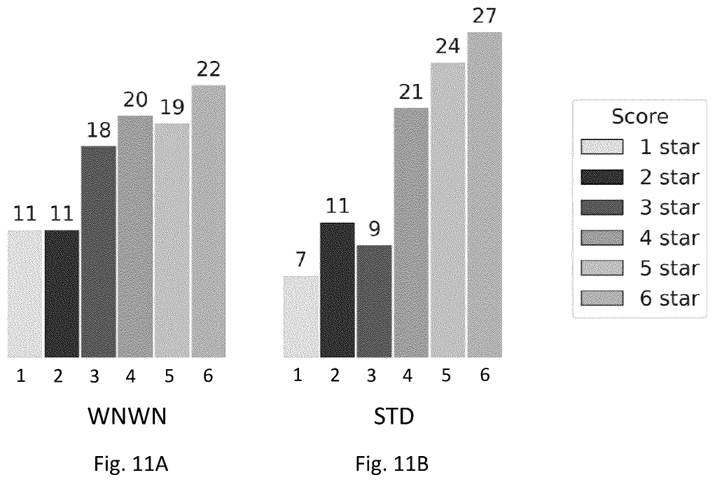

FIGS. 11A and 11B are charts showing the score breakdown of response to the question of “if the product was chocolate”, comparison was made between conventional cocoa-containing chocolate (STD) and cocoa-free chocolate (WNWN). The cocoa-free chocolate (WNWN) had an overall response score of 3.94 compared to cocoa-containing chocolate (STD) which had an overall response score of 4.26. Therefore, the cocoa-free chocolate was found to be very similar to the cocoa-containing chocolate.

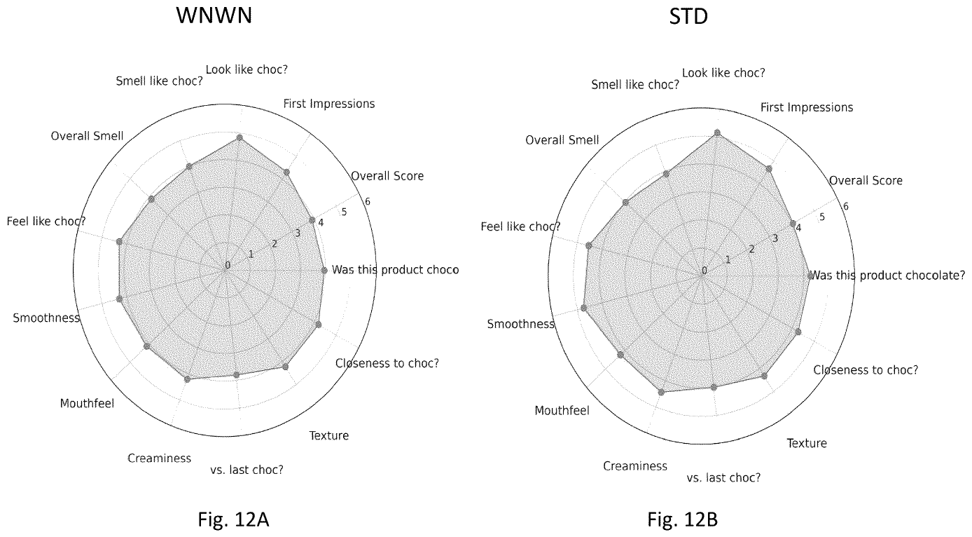

FIGS. 12A and 12B are comparative spider plots showing the score breakdown of conventional cocoa-containing chocolate (STD) and cocoa-free chocolate (WNWN). Comparison of the spider plots indicates that the conventional cocoa-containing chocolate (STD) and WNWN cocoa-free chocolate (WNWN) had similar response in the test subjects, and that the two products were found to be very similar.

### Example 16: Additional Dark and Milk Cocoa-Free Chocolate Compositions

TABLE 10

| | Name | | | | |
|---|---|---|---|---|---|
| | Vegan milk | Dark | Dark | Dark | Dark |
| | #668 | #550 | #752 | #476 | #384 |
| Ingredient | % wt | % wt | % wt | % wt | % wt |
| Vegetable fat | 38.5 | 38.9 | 39 | 39 | 44.8 |
| Carob powder | 10.6 | 35.2 | 19.2 | 36.5 | 32.9 |
| Barley | 2.4 | 2.4 | 1.7 | 2.4 | 2 |
| Sugar | 30 | 19.7 | 30 | 19.8 | 17 |
| Lecithin | 0.7 | 0.7 | 0.2 | 0.7 | 0.7 |
| Salt | 0.03 | 0.03 | 0.02 | 0 | 0.1 |
| Tiger nut | 5 | 0 | 5 | 0 | 0 |
| Grape seed | 1.1 | 1.1 | 1.1 | 1 | 1.5 |
| Acetic acid | 0 | 0 | 0 | 0.1 | 0 |
| Sunflower | 0 | 0 | 2.5 | 0 | 0 |
| seed | | | | | |
| Cherries | 1 | 1 | 0.4 | 0 | 0 |
| Rose hip | 0 | 0 | 0 | 0 | 0.3 |
| Chicory root | 0 | 0 | 0 | 0 | 0.3 |
| Pumpkin seed | 10 | 0 | 0 | 0 | 0 |
| flour | | | | | |
| Vanilla | 0 | 0 | 0.2 | 0.01 | 0 |
| Malted barley | 0.7 | 0.7 | 0.6 | 0.6 | 0.5 |
| Soybeans | 0 | 0.2 | 0 | 0 | 0 |

The vegetable fat comprised slightly different combinations of shea butter, illipe butter and/or palm oil; the barley was roasted fermented barley paste; acetic acid was used as powder; and the soy beans were fermented soy beans.

A cocoa-free milk chocolate composition and chocolate bars were prepared from the above ingredients by a process similar to that described in Example 1.

1.-43. (canceled)

44. A cocoa-free chocolate composition comprising:
1-65% wt of at least one non-animal fat;
5-55% wt of at least one legume component; and
0.1-25% wt of at least one fermented cereal grain.

45. The cocoa-free chocolate composition according to claim 44, wherein the at least one non-animal fat comprises a plant-based fat.

46. The cocoa-free chocolate composition according to claim 44, wherein the at least one non-animal fat comprises shea butter, illipe butter and/or palm oil.

47. The cocoa-free chocolate composition according to claim 44, wherein the at least one legume component comprises carob powder and/or roasted carob powder.

48. The cocoa-free chocolate composition according to claim 47, wherein the roasted carob powder comprises at least two roasted carob powders which have been roasted at different temperatures and/or for different lengths of time.

49. The cocoa-free chocolate composition according to claim 44, wherein the at least one fermented cereal grain is fermented barley.

50. The cocoa-free chocolate composition according to claim 44, wherein the cocoa-free chocolate composition does not comprise a dairy product.

51. The cocoa-free chocolate composition according to claim 44, further comprising a non-dairy milk component.

52. The cocoa-free chocolate composition according to claim 51, wherein the non-dairy milk component comprises oat milk.

53. The cocoa-free chocolate composition according to claim 44, wherein the cocoa-free chocolate composition comprises less than 25% wt sugar.

54. The cocoa-free chocolate composition according to claim 44, wherein the at least one fermented cereal grain and the at least one legume component are present at a ratio of about 1:5-1:25 wt/wt in the cocoa-free chocolate composition.

55. The cocoa-free chocolate composition according to claim 44, wherein the at least one legume comprises carob powder, and the at least one fermented cereal grain comprises roasted fermented barley.

56. The cocoa-free chocolate composition according to claim 55, wherein the roasted fermented barley is present in the composition in an amount of about 0.5-15% wt, and the carob powder is present in the composition in an amount of about 8-40% wt.

57. The cocoa-free chocolate composition according to claim 44, wherein the non-animal fat comprises shea butter, illipe butter, and/or palm oil, and is present in the composition in an amount of about 30-50% wt.

58. The cocoa-free chocolate composition of claim 44, wherein the cocoa-free chocolate composition does not contain particles larger than 70 microns.

59. The cocoa-free chocolate composition of claim 44, wherein the composition comprises particles of which at least 90% have a size smaller than about 20 microns.

60. A cocoa-free chocolate product prepared from the cocoa-free chocolate composition of claim 44.

61. A method for the preparation of a cocoa-free chocolate composition comprising:
fermenting a cereal grain;
roasting the fermented cereal grain; and
mixing the roasted fermented cereal grain with at least one non-animal fat and at least one legume component to form a cocoa-free chocolate composition comprising:
1-65% wt of the at least one non-animal fat;
5-55% wt of the at least one legume component; and
0.1-25% wt of the roasted fermented cereal grain.

62. The method according to claim 61, wherein the fermenting is performed by incubating the cereal grain with at least one microorganism selected from the group consisting of Aspergillus oryzae, Bacillus subtilis, Aspergillus sojae, Rhizopus oligosporus, Rhizopus oryzae, Neurospora intermedia var. Oncomensis, Aspergillus luchuensis, Lactococcus lactis subsp, B, Bacillus sp., Bacillus licheniformis, Bacillus giant, Bacillus pumilus, Bacillus amylolitica, Bacillus methylotrophic, Bacillus proteolysaccharide, Bacillus brevis, Laceyella Sacchari, Corynebacterium glutamicum, Saccharomyces cerevisiae, Candida krusei, Candida parapsilosis, Candida glabrata, Candida tropicalis, Candida guillermondii, Candida rugosa, Pichia kudriavzevii, and any combination thereof.

63. The method according to claim 61, wherein roasting the fermented cereal grain is conducted at a temperature of about 30-65° C.
